(19) United States
(12) Patent Application Publication
(10) Pub. No.: US 2002/0191015 A1
(43) Pub. Date: Dec. 19, 2002

(54) Method and apparatus for managing history logs in a data processing system

(75) Inventors: Michael Wayne Brown, Georgetown, TX (US); Michael Aaron Kaply, Austin, TX (US); Aaron Keith Reed, Austin, TX (US); Cristi Nesbitt Ullmann, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/884,492

(22) Filed: Jun. 18, 2001

(51) Int. Cl. G06F 3/00; G06F 13/00

(52) U.S. Cl. 345/738

(57) ABSTRACT

A method and apparatus for managing a history for a browser in a data processing system. A history is recorded for a browser. The history may be presented to the user in a fashion similar to a video or slide show presentation in which Web pages in the history are sequentially presented in the order of visitation. The presentation of the history may be manipulated through a set of controls, such as a play button, a reverse button, a fast forward button, and a stop button. Potions of the history may be deleted or selectively exported for analysis or later use.

### BACKGROUND OF THE INVENTION

1. Technical Field

The present invention relates generally to an improved data processing system, and in particular to a method and apparatus for managing data. Still more particularly, the present invention provides a method, apparatus, and computer implemented instructions for managing history logs generated by a browser.

2. Description of Related Art

The Internet, also referred to as an “internetwork”, is a set of computer networks, possibly dissimilar, joined together by means of gateways that handle data transfer and the conversion of messages from protocols of the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients affect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

A history list is recorded to identify URLs that have been visited by a user. Also, a location list containing URLs entered by the user is present. In some instances, a user may desire to write to a file the specific sites visited during one session or the ability re-run the same history list.

Therefore, it would be advantageous to have an improved method and apparatus for identifying and presenting the history of Web pages viewed by a user.

### SUMMARY OF THE INVENTION

The present invention provides for a method and apparatus for managing a history for a browser in a data processing system. A history is recorded for a browser during a browsing session and saved in a file. The history may be presented to a user in a fashion similar to a video or slide show presentation in which Web pages in the history are sequentially presented in the order of visitation. The presentation of the history may be manipulated through a set of controls, such as a play button, a reverse button, a fast forward button, and a stop button. Portions of the history may be deleted and/or selectively exported for analysis or later use.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating components used in disabling recording of a history in accordance with a preferred embodiment of the present invention;

FIG. 4 is a block diagram of a browser program in accordance with a preferred embodiment of the present invention;

FIG. 5 is a diagram of a graphical user interface used to present and manipulate a log in accordance with a preferred embodiment of the present invention;

FIG. 6 is a diagram of a graphical user interface used to present and manipulate a log in accordance with a preferred embodiment of the present invention;

FIG. 7 is a flowchart of a process used for logging Web site visitations in accordance with a preferred embodiment of the present invention;

FIG. 8 is a flowchart of a process used for manipulating presentation of a log in accordance with a preferred embodiment of the present invention;

FIG. 9 is a flowchart of a process used for manipulating presentation of a log in accordance with a preferred embodiment of the present invention; and

FIG. 10 is a flowchart of a process used for exporting a log in accordance with a preferred embodiment of the present invention.

### DETAILED DESCRIPTION OF THE PREFERRED EMBODIMENT

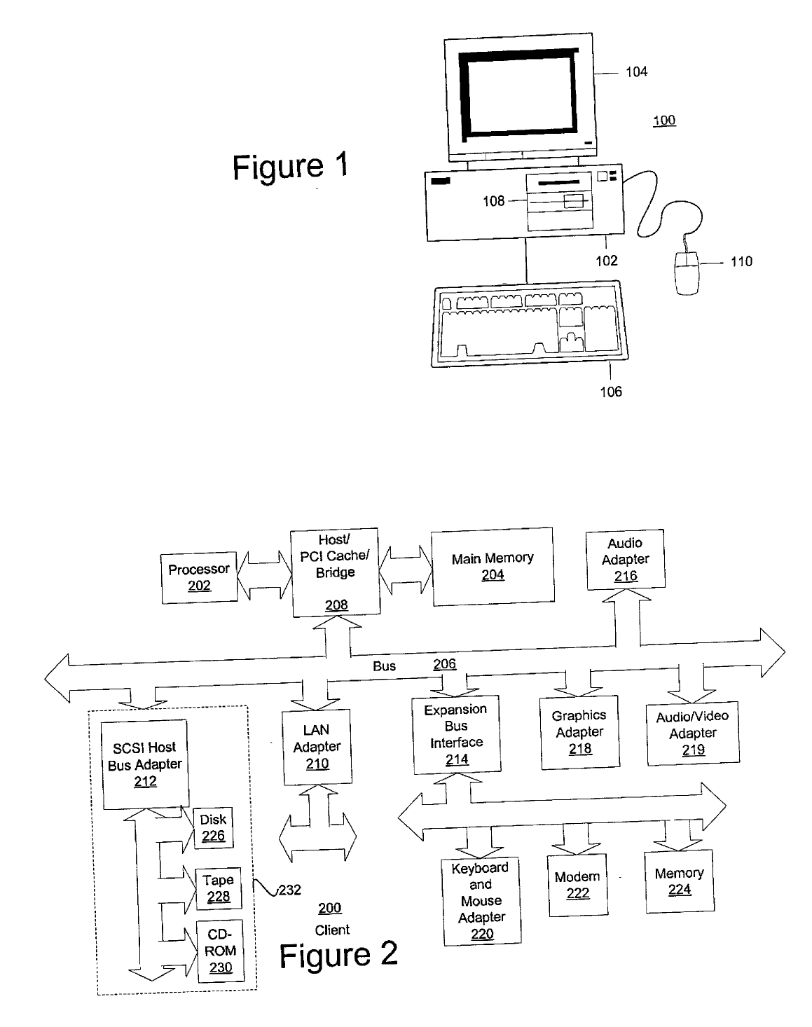

With reference now to the figures and in particular with reference to FIG. 1, a pictorial representation of a data processing system in which the present invention may be implemented is depicted in accordance with a preferred embodiment of the present invention. A computer 100 is depicted which includes a system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

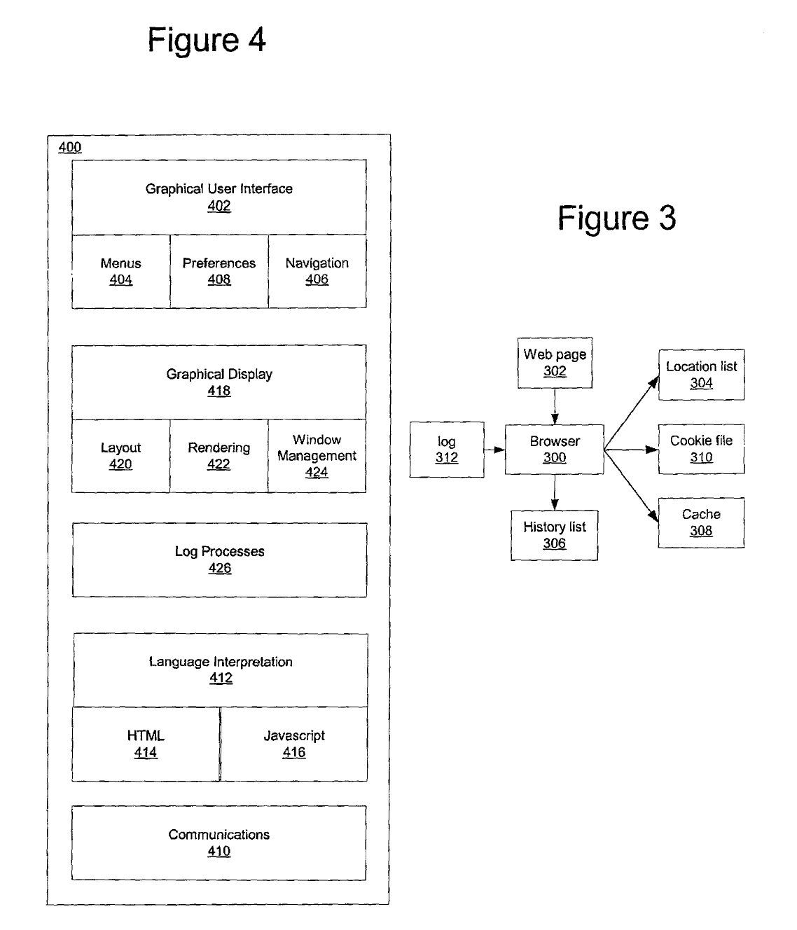

With reference now to FIG. 3, a diagram illustrating components used in disabling recording of a history is depicted in accordance with a preferred embodiment of the present invention. Browser 300 is an example of a browser, which may be executing on data processing system 200 in FIG. 2.

In this example, browser 300 receives Web page 302 for presentation. Web page 302 may be obtained by entering a URL. This URL may be stored in location list 304. Location list 304 contains URLs entered by the user. These URLs are typically entered through a field, which is often called an “address bar”. Additionally, the URL may be stored in history list 306. Further, history list 306 stores URLs to sites visited by the user by other means, such as a selection of a link. History list 306 also may contain a record of the date and time a Web page was visited by the user.

Cache 308 provides for temporary storage of Web pages received by the browser. For example, images and text for Web page 302 may be stored in cache 308. Cache 308 provides a quick way to redisplay Web page 302 if the user later returns to Web page 302. Another storage of information that may be used to trace or identify Web pages visited by a user is cookie file 310. A hidden data field, which may be included in the HTTP header of an HTML file, is a “cookie” data field. A cookie is an HTTP protocol header document element, which may be used to provide multiple data elements to the browser. Some Web sites may not function properly when the acceptance of cookies is disabled by the browser. Therefore, a user may not be able to access a Web site without having cookies accepted by the browser.

The information collected and stored by browser 300 are examples of data that form a history. The present invention provides a method, apparatus, and computer implemented instructions for logging Web site visitations. The mechanism of the present invention generates log 312, which is a record of a Web site visited by a user during a browser session using browser 300. This log may include, for example, a title for the Web page visited, the specific URL address, when a user first visited this site, when the user last visited this site the expiration time, the number of times the user has visited this site, the site most often visited, and the sites visited by the user by days. Additionally, the mechanism of the present invention provides a graphical user interface to present a log to the users. This interface allows the user to decide which portions of the log to keep, delete, or package for export. In this example, the log is presented as a video or slide show in which Web pages retrieved by the browser are presented for review. The controls in the interface may allow the user to manipulate the log in a fashion similar to a video. For example, a user may fast forward, reverse, or alter the speed at which Web pages are presented. Additionally, an index or tree view may be provided for selecting portions of the log for presentation. This log also may be stored or exported for review at a later time.

Turning next to FIG. 4, a block diagram of a browser program is depicted in accordance with a preferred embodiment of the present invention. A browser is an application used to navigate or view information or data in a distributed database, such as the Internet or the World Wide Web. In particular, processes may be included within browser 400 to disable recording a history.

In this example, browser 400 includes a user interface 402, which is a graphical user interface (GUI) that allows the user to interface or communicate with browser 400. This interface provides for selection of various functions through menus 404 and allows for navigation through navigation 406. For example, menu 404 may allow a user to perform various functions, such as saving a file, opening a new window, displaying a history, and entering a URL. Navigation 406 allows for a user to navigate various pages and to select web sites for viewing. For example, navigation 406 may allow a user to see a previous page or a subsequent page relative to the present page. Additionally, menu 404 may allow a user to disable history recording through the selection of a button. The processes in graphical user interface 402 are employed to present logs to the user as well as receive user input used to manipulate the logs.

Preferences such as those illustrated in FIG. 4 may be set through preferences 408. The disablement of this history recording is accomplished by setting a preference in preference 408.

Communications 410 is the mechanism with which browser 400 receives documents and other resources from a network such as the Internet. Further, communications 410 is used to send or upload documents and resources onto a network. In the depicted example, communication 410 uses HTTP. Other protocols may be used depending on the implementation. Documents that are received by browser 400 are processed by language interpretation 412, which includes HTML unit 414 and JavaScript unit 416. Language interpretation 412 will process a document for presentation on graphical display 418. In particular, HTML statements are processed by HTML unit 414 for presentation while JavaScript statements are processed by JavaScript unit 416.

Graphical display 418 includes layout unit 420, rendering unit 422, and window management 424. These units are involved in presenting Web pages to a user based on results from language interpretation 412.

Log processes 426 include the processes of the present invention used to log Web site visitation as well as present and manipulate the logs. Log processes 426 employs graphical user interface 402 to provide input/output in presenting logs and receiving user input manipulating the logs. In these examples, the processes are shown as being implemented within log processes 426 for purposes of illustration. The mechanism of the present invention may be implemented in other ways depending on the particular implementation. For example, these processes may be implemented as a plug-in or as a separate application.

Browser 400 is presented as an example of a browser program in which the present invention may be embodied. Browser 400 is not meant to imply architectural limitations to the present invention. Presently available browsers may include additional functions not shown or may omit functions shown in browser 400. A browser may be any application that is used to search for and display content on a distributed data processing system. Browser 400 make be implemented using know browser applications, such Netscape Navigator or Microsoft Internet Explorer. Netscape Navigator is available from Netscape Communications Corporation while Microsoft Internet Explorer is available from Microsoft Corporation.

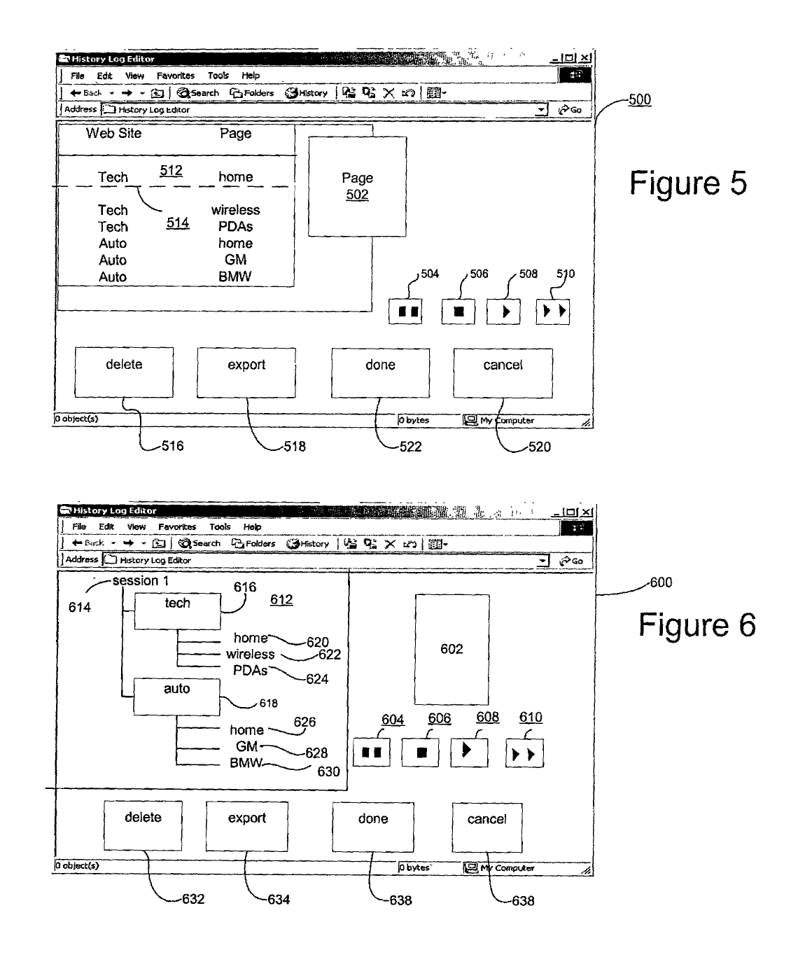

Turning next to FIG. 5, a diagram of a graphical user interface used to present and manipulate a log is depicted in accordance with a preferred embodiment of the present invention. Graphical user interface 500 may be implemented in browser 400 in FIG. 4.

In this example, graphical user interface 500 takes the form of a window. Web pages contained in the log are presented within page field 502. These Web pages are presented in a fashion similar to a video or slide show. A user may manipulate the presentation using reverse button 504, stop button 506, play button 508, and fast forward button 510. Additionally, index field 512 presents information, such as Web site and page to the user. A particular entry in index field 512 may be emphasized by underlying 514. Of course, other indicators, such as highlighting or font changes may be used to indicate a particular page being presented within page field 502. A user may delete an entire log by selecting “Delete” button 516. Portions of a log may be deleted by selecting a particular Web page from index field 512 and selecting “Delete” button 516. “Export” button 518 allows for a log to exported for use or review by another program or computer system. Selection of “Cancel” button 520 cancels any selections made in graphical user interface 500. “Done” button 522 is selected to close graphical user interface 500.

Turning next to FIG. 6, a diagram of a graphical user interface used to present and manipulate a log is depicted in accordance with a preferred embodiment of the present invention. Graphical user interface 600 may be implemented in a browser, such as browser 400 in FIG. 4.

Page field 602 is the portion of graphical user interface used to present Web pages similar to page field 502 in FIG. 5. Reverse button 604, stop button 606, play button 608, and fast forward button 610 provide controls used to manipulate the presentation of Web pages from a log within page field 602. Tree field 612 provides a tree presentation of information within the log. Node 614 indicates a particular session while nodes 616 and 618 identify Web sites within the log. Nodes 620, 622, 624, 626, 628, and 630 identify Web pages within the log. Selection of a node identifying a Web page results in presentation of the page within page Field 602.

“Delete” button 632, “Export” button 634, “Done” button 636, and “Cancel” button 638 provide functions similar to “Delete” button 516, “Export” button 518, “Cancel” button 520, and “Done” button 522 in FIG. 5.

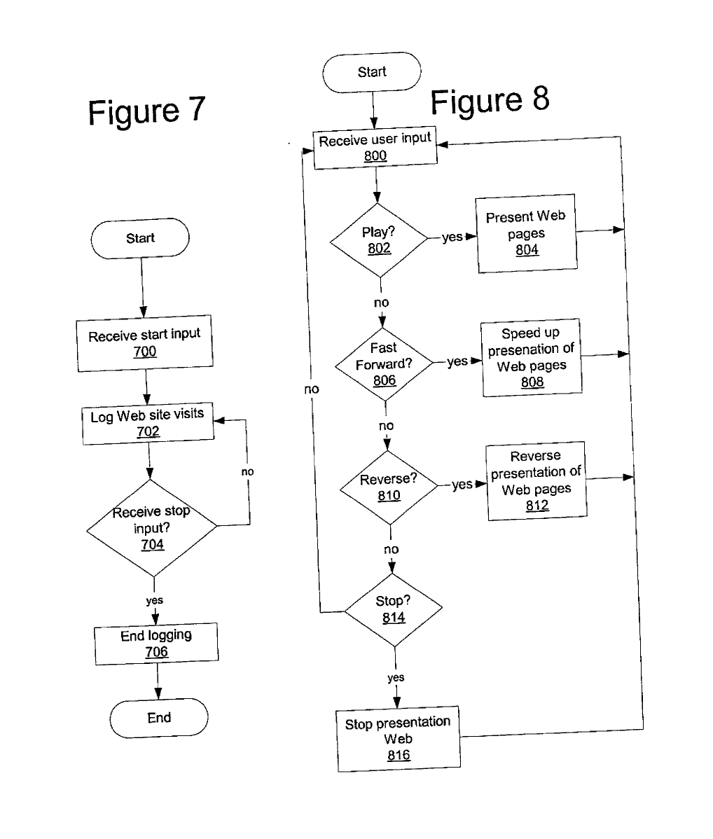

Turning next to FIG. 7, a flowchart of a process used for logging Web site visitations is depicted in accordance with a preferred embodiment of the present invention. The process illustrated in FIG. 7 may be implemented in a browser, such as browser 400 in FIG. 4.

The process begins by receiving a start input (step 700). This start input may take various forms. For example, a start input may be an initiation of a browser session or a user input. Next, Web sites visited are placed in a log (step 702). This log file may include one or more of the following: the title, the URL address, the first visited time, the last visited time, the expiration time, the visit count, date visited, and most recently visited. A determination is made as to whether a stop input is received (step 704). A stop input may be, for example, the termination of a browser session or a user input. If a stop input is not received, the process returns to step 702 as described above. Otherwise, the logging ends (step 706) with the process terminating thereafter.

With reference now to FIG. 8, a flowchart of a process used for manipulating presentation of a log is depicted in accordance with a preferred embodiment of the present invention. The process illustrated in FIG. 8 may be implemented in a browser, such as browser 400 in FIG. 4 in presenting a graphical user interface, such as graphical user interface 500 in FIG. 5 or graphical user interface 600 in FIG. 6.

The process begins by receiving a user input (step 800). A determination is made as to whether the user input is a selection of a play button (step 802). If the user input is a selection of a play button, then Web pages are presented to the user (step 804) with the process returning to step 800. The presentation in these examples is made in a page field, such as page field 502 in FIG. 5. A presentation is a sequential display of Web pages within the log. This presentation is similar to a video or slide show.

Next, if the play button is not selected in step 802, a determination is made as to whether the user input is a selection of a fast forward button (step 806). If the user input is a selection of a fast forward button, then the presentation of Web pages is increased at a speed faster than the normal play speed (step 808) with the process returning to step 800 thereafter. With reference again to step 806, if the user input is not a selection of the fast forward button, a determination is made as to whether the user input is a selection the reverse button (step 810). If the user input is a selection of the reverse button, then the presentation of the Web pages is reversed (step 812) with the process then returning to step 800.

If in step 810, the reverse button is not the selected user input, a determination is made as to whether a stop button is selected by the user input (step 814). If the user input is a selection of a stop button, the presentation of the Web pages is halted (step 816) with the process then returning to step 800 as described above. Otherwise, the process returns to step 800 without any other action being taken with respect to the presentation of the Web pages.

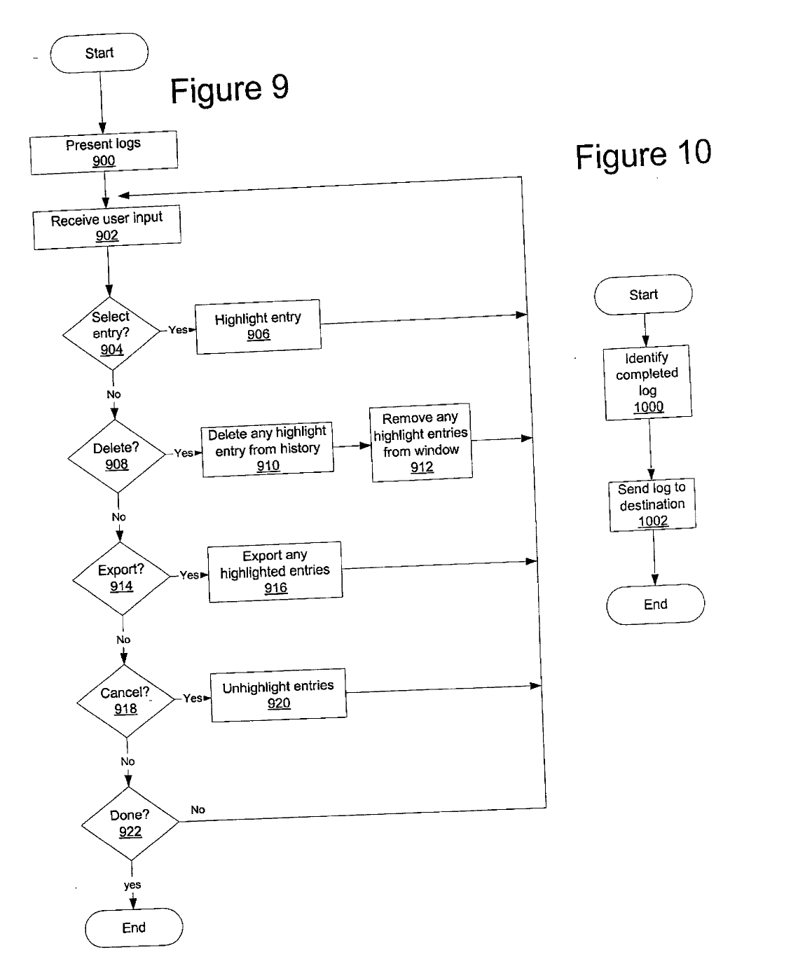

With reference now to FIG. 9, a flowchart of a process used for manipulating presentation of a log is depicted in accordance with a preferred embodiment of the present invention. The process illustrated in FIG. 9 may be implemented in a browser, such as browser 400 in FIG. 4 in presenting a graphical user interface, such as graphical user interface 500 in FIG. 5 or graphical user interface 600 in FIG. 6.

The process begins by presenting logs to a user (step 900). Next, a user input is received (step 902). A determination is made as to whether the user input is the selection of an entry (step 904). The entry may be an entry or node, such as those illustrated in index field 512 in FIG. 5 or tree field 614 in FIG. 6. If the user input is a selection of an entry, the entry is highlighted (step 906) and the process returns to step 902 as described above. If the user input is not the selection of an entry, a determination is made as to whether the user input is the selection of a delete button (step 908). If the user input is the selection of a delete button, all highlighted entries are deleted from the history (step 910). Then, any highlighted entries are removed from the window (step 912) and the process returns to step 902 as described above.

If the user input is not a selection of a deleted button, a determination is made as to whether the user input is the selection of an export button (step 914). If the user input is a selection of an export button, any highlighted entries are exported (step 916) with the process then returning to step 902 as described above. In exporting the entries, the entries are stored in a data structure either locally on the data processing system or on a remote data processing system.

If the export button is not selected, a determination is made as to whether the user input is a selection of a cancel button (step 918). If the user input is the selection of a cancel button, all highlighted entries are un-highlighted (step 920) and the process returns to step 902 as described above.

If the user input is not the selection of a cancel button, a determination is made as to whether the user input is the selection of a done button (step 922). If the user input is the selection of a done button, the process terminates. Otherwise, the process returns to step 902 as described above.

Turning next to FIG. 10, a flowchart of a process used for exporting a log is depicted in accordance with a preferred embodiment of the present invention. The process illustrated in FIG. 10 is a more detailed description of step 916 in FIG. 9.

The process begins by identifying a completed log (step 1000). The completed log is either an entire log or entries within a log selected by a user for export. Next, the completed log is sent to a destination (step 1002) with the process terminating thereafter. The destination may be a local or remote storage device.

Thus, the present invention provides an improved method, apparatus, and computer implemented instructions for presenting and managing logs of Web sites visited using a browser. This advantage is provided through a graphical user interface for presenting logs to the user and through processes used to manipulate and export the logs. The mechanism of the present invention avoids requiring a user to perform numerous steps to locate and review previously visited Web sites.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing a history for a browser, the method comprising:
recording a history for a browser; and
selectively exporting a portion of the history for analysis.

2. The method of claim 1, wherein the portion covers a period of time.

3. The method of claim 2, wherein the period of time is for a session.

4. The method of claim 1 further comprising:
presenting the portion of the history.

5. The method of claim 2, wherein the portion includes a set of Web pages visited during the period of time.

6. The method of claim 1 further comprising:
displaying a graphical representation of the history; and
receiving user input to select the portion of the history.

7. The method of claim 6, wherein the graphical representation is in a form of a tree.

8. The method of claim 6, wherein the graphical representation is in a form of a set of entries in a window.

9. The method of claim 1, wherein the recording step is initiated in response to a beginning of a browser session.

10. The method of claim 9, wherein the recording step terminates in response to a termination of the browsing session.

11. The method of claim 1, wherein the recording step is initiated in response to a user input.

12. A method in a data processing system for logging browsing activities for a browser, the method comprising:
logging Web pages visited using the browser to form a log;
presenting the log;
receiving a selection of a portion of the log; and
storing the log in response to receiving the selection.

13. The method of claim 12, wherein the log includes a plurality of browsing sessions.

14. The method of claim 12, wherein the selection is received from a user input.

15. The method of claim 12, wherein the log is stored in a storage device located within the data processing system.

16. The method of claim 12, wherein the log is stored in a storage device located in a remote data processing system.

17. The method of claim 12, wherein the storing step forms a stored log and further comprising:
presenting Web pages in the portion of the log in response to an event.

18. The method of claim 17, wherein the event is a user input.

19. A method in a data processing system for presenting a history of browser activities, the method comprising:
logging Web pages received by a browser session to form a log; and
sequentially displaying Web pages from the log.

20. The method of claim 19 further comprising:
receiving a user input manipulating presentation for the Web pages.

21. The method of claim 20, wherein the user input is one of a play, fast forward, reverse, or stop.

22. A data processing system comprising:
a bus system;
a communications unit connected to the bus system;
a memory connected to the bus system, wherein the memory includes a set of instructions; and
a processing unit connected to the bus system, wherein the processing unit executes the set of instructions to record a history for a browser; and selectively export a portion of the history for analysis.

23. A data processing system comprising:
a bus system;
a communications unit connected to the bus system;
a memory connected to the bus system, wherein the memory includes a set of instructions; and
a processing unit connected to the bus system, wherein the processing unit executes the set of instructions to log Web pages visited using the browser to form a log; present the log; receive a selection of a portion of the log; and store the log in response to receiving the selection.

24. A data processing system comprising:
a bus system;
a communications unit connected to the bus system;
a memory connected to the bus system, wherein the memory includes a set of instructions; and
a processing unit connected to the bus system, wherein the processing unit executes the set of instructions to log Web pages received by a browser session to form a log; and sequentially display Web pages from the log.

25. A data processing system for managing a history for a browser, the data processing system comprising:
recording means for recording a history for a browser; and
selectively exporting means for selectively exporting a portion of the history for analysis.

26. The data processing system of claim 25, wherein the portion covers a period of time.

27. The data processing system of claim 26, wherein the period of time is for a session.

28. The data processing system of claim 25 further comprising:
presenting means for presenting the portion of the history.

29. The data processing system of claim 26, wherein the portion includes a set of Web pages visited during the period of time.

30. The data processing system of claim 25 further comprising:
displaying means for displaying a graphical representation of the history; and
receiving means for receiving user input to select the portion of the history.

31. The data processing system of claim 30, wherein the graphical representation is in a form of a tree.

32. The data processing system of claim 30, wherein the graphical representation is in a form of a set of entries in a window.

33. The data processing system of claim 25, wherein the recording means is initiated in response to a beginning of a browser session.

34. The data processing system of claim 33, wherein the recording means terminates in response to a termination of the browsing session.

35. The method of claim 25, wherein the recording means is initiated in response to a user input.

36. A data processing system for logging browsing activities for a browser, the data processing system comprising:
logging means for logging Web pages visited using the browser to form a log;
presenting means for presenting the log;
receiving means for receiving a selection of a portion of the log; and
storing means for storing the log in response to receiving the selection.

37. The data processing system of claim 36, wherein the log includes a plurality of browsing sessions.

38. The data processing system of claim 36, wherein the selection is received from a user input.

39. The data processing system of claim 36, wherein the log is stored in a storage device located within the data processing system.

40. The data processing system of claim 36, wherein the log is stored in a storage device located in a remote data processing system.

41. The data processing system of claim 36, wherein the storing means forms a stored log and further comprising:
means for presenting Web pages in the portion of the log in response to an event.

42. The data processing system of claim 41, wherein the event is a user input.

43. A data processing system for presenting a history of browser activities, the data processing system comprising:
logging means for logging Web pages received by a browser session to form a log; and
sequentially displaying means for sequentially displaying Web pages from the log.

44. The data processing system of claim 43 further comprising:
receiving means for receiving a user input manipulating presentation for the Web pages.

45. The data processing system of claim 44, wherein the user input is one of a play, fast forward, reverse, or stop.

46. A computer program product in a computer readable medium for managing a history for a browser, the computer program product comprising:
first instructions for recording a history for a browser; and
second instructions for selectively exporting a portion of the history for analysis.

47. A computer program product in a computer readable medium for logging browsing activities for a browser, the computer program product comprising:
first instructions for logging Web pages visited using the browser to form a log;
second instructions for presenting the log;
third instructions for receiving a selection of a portion of the log; and
fourth instructions for storing the log in response to receiving the selection.

48. A computer program product in a computer readable medium presenting a history of browser activities, the computer program product comprising:
first instructions for logging Web pages received by a browser session to form a log; and
second instructions for sequentially displaying Web pages from the log.
